(19) United States
(12) Patent Application Publication
(10) Pub. No.: US 2026/0352273 A1
(43) Pub. Date: Nov. 5, 2026

(54) ANTENNA SELECTION WITH SUB-BAND FULL-DUPLEX SYSTEMS

(71) Applicant: QUALCOMM Incorporated, San Diego, CA (US)

(72) Inventors: Vasanthan RAGHAVAN, West Windsor Township, NJ (US); Tao LUO, San Diego, CA (US)

(21) Appl. No.: 19/643,340

(22) Filed: Apr. 9, 2026

Related U.S. Application Data
(60) Provisional application No. 63/797,655, filed on Apr. 30, 2025.

(51) Int. Cl. H04B 7/06; H04B 7/08; H04L 5/14

(52) U.S. Cl. CPC H04B 7/0608; H04B 7/0632; H04B 7/0802; H04L 5/14

(57) ABSTRACT

Various aspects of the present disclosure generally relate to wireless communication. In some aspects, a user equipment (UE) receives multiple channel state information (CSI) metrics that are based at least in part on cross-link interference measurements. The UE selects a set of antennas for communication based at least in part on the multiple CSI metrics. The UE communicates a message using the selected set of antennas. Numerous other aspects are described.

### CROSS-REFERENCE TO RELATED APPLICATION

This Patent Application claims priority to U.S. Provisional Patent Application No. 63/797,655, filed on Apr. 30, 2025, entitled “ANTENNA SELECTION WITH SUB-BAND FULL-DUPLEX SYSTEMS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with antenna selection with sub-band full-duplex systems.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a method of wireless communication performed by user equipment (UE). The method may include receiving multiple channel state information (CSI) metrics that are based at least in part on multiple cross-link interference (CLI) measurements. The method may include selecting a set of antennas for communication based at least in part on the multiple CSI metrics. The method may include communicating (transmitting or receiving) a message using the selected set of antennas.

Some aspects described herein relate to a method of wireless communication performed by a network entity. The method may include measuring CLI based at least in part on reception of a reference signal on a first sub-band, during transmission of a message on a second sub-band as part of sub-band full-duplex (SBFD) operation. The method may include transmitting multiple CSI metrics that are based at least in part on measured CLI.

Some aspects described herein relate to a UE. The UE may include a processing system. The processing system may include one or more processors and one or more code-storing memories coupled with the one or more processors. The processing system may be configured to cause the UE to receive multiple CSI metrics that are based at least in part on multiple CLI measurements. The processing system may be configured to cause the UE to select a set of antennas for communication based at least in part on the multiple CSI metrics. The processing system may be configured to cause the UE to communicate a message using the selected set of antennas.

Some aspects described herein relate to a network entity. The network entity may include a processing system. The processing system may include one or more processors and one or more code-storing memories coupled with the one or more processors. The processing system may be configured to cause the network entity to measure CLI based at least in part on reception of a reference signal on a first sub-band, during transmission of a message on a second sub-band as part of SBFD operation. The processing system may be configured to cause the network entity to transmit multiple CSI metrics that are based at least in part on measured CLI.

Some aspects described herein relate to a non-transitory computer-readable medium that stores a set of instructions for wireless communication by a UE. The set of instructions, when executed by one or more processors of the UE, may cause the UE to receive multiple CSI metrics that are based at least in part on multiple CLI measurements. The set of instructions, when executed by one or more processors of the UE, may cause the UE to select a set of antennas for communication based at least in part on the multiple CSI metrics. The set of instructions, when executed by one or more processors of the UE, may cause the UE to communicate a message using the selected set of antennas.

Some aspects described herein relate to a non-transitory computer-readable medium that stores a set of instructions for wireless communication by a network entity. The set of instructions, when executed by one or more processors of the network entity, may cause the network entity to measure CLI based at least in part on reception of a reference signal on a first sub-band, during transmission of a message on a second sub-band as part of SBFD operation. The set of instructions, when executed by one or more processors of the network entity, may cause the network entity to transmit multiple CSI metrics that are based at least in part on measured CLI.

Some aspects described herein relate to an apparatus for wireless communication. The apparatus may include means for receiving multiple CSI metrics that are based at least in part on multiple CLI measurements. The apparatus may include means for selecting a set of antennas for communication based at least in part on the multiple CSI metrics. The apparatus may include means for communicating a message using the selected set of antennas.

Some aspects described herein relate to an apparatus for wireless communication. The apparatus may include means for measuring CLI based at least in part on reception of a reference signal on a first sub-band, during transmission of a message on a second sub-band as part of SBFD operation. The apparatus may include means for transmitting multiple CSI metrics that are based at least in part on measured CLI.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of sub-band full-duplex (SBFD) and non-SBFD symbols.

FIG. 3 is a diagram illustrating an example of channel quality indicator (CQI) feedback.

FIG. 4 is a diagram illustrating an example of providing channel state information metrics based on cross-link interference measurements.

FIG. 5 is a diagram illustrating an example process performed, for example, at a user equipment (UE) or an apparatus of a UE.

FIG. 6 is a diagram illustrating an example process performed, for example, at a network entity or an apparatus of a network entity.

FIG. 7 is a diagram of an example apparatus for wireless communication.

FIG. 8 is a diagram of an example apparatus for wireless communication.

### DETAILED DESCRIPTION

In many user equipment (UE) implementations, there can be more antennas available than the number of independent measurements that can be performed over each reference signal occasion. This is particularly relevant in frequency range one (FR1) and frequency range three (FR3), where UEs can have six or eight antennas. However, due to power consumption and thermal overhead considerations, not all antenna elements or radio frequency chains can be activated simultaneously. A UE can select a subset of antennas to optimize these factors.

Sub-band full-duplex (SBFD) is a wireless communication technique where a network entity (e.g., gNB) transmits and receives signals simultaneously over different, non-overlapping sub-bands within the same frequency band. This approach may improve spectral efficiency and may reduce latency by enabling concurrent uplink and downlink communications. However, for SBFD symbols, there may be cross-link interference (CLI) between transmitted signals on a downlink (DL) band and received signals on an uplink (UL) band that can degrade the accuracy of channel feedback, such as channel quality indicators (CQIs) that quantify the modulation and coding scheme (MCS) to use over the channel. That is, CLI in SBFD symbols can reduce the reliability of feedback to the UE.

Additionally, the network entity is expected to differentiate between feedback for SBFD symbols and for non-SBFD symbols. In SBFD symbols, the network entity transmits and receives over different sub-bands within the same time slot, whereas in non-SBFD symbols, the network entity either transmits or receives, but not both. This differentiation is relevant because the CQI estimates for SBFD symbols are likely to be less accurate due to CLI, compared to CQI estimates for non-SBFD symbols where no such interference exists.

Various aspects relate generally to antenna selection in wireless communication systems, specifically with SBFD operations. Some aspects more specifically relate to a network entity operating in an SBFD mode that measures CLI caused by simultaneous transmission and reception over different sub-bands. Based on these CLI measurements, the network entity may compute channel state information (CSI) metrics, such as uplink CQIs, downlink CQIs, uplink MCSs, downlink MCSs, signal-to-noise ratios (SNRs), or signal strength values, among other CSI metrics. The network entity may transmit multiple CSI metrics to the UE. The UE may select a set of antennas based on the multiple CSI metrics that account for CLI measurements. The selection can be optimized for power consumption and thermal overhead.

In some aspects, the network entity may transmit multiple sets of CSI metrics, each set of CSI metrics corresponding to different sub-bands or different symbol types (e.g., UL, DL, SBFD, non-SBFD). For instance, CSI metrics may be differentiated based on whether the CSI metrics are associated with SBFD symbols or non-SBFD symbols. The UE receives these differentiated CSI metrics and selects a set of (one or more) antennas for uplink and downlink communication based at least in part on the CSI metrics. The UE may select the set of antennas from available antennas based at least in part on power consumption considerations, to optimize performance, or a combination thereof.

Particular aspects of the subject matter described in this disclosure can be implemented to realize one or more of the following technical advantages. By transmitting multiple CSI metrics that account for CLI, the network entity may provide the UE with more accurate and context-specific information, enabling better antenna selection. This improves the reliability and quality of communication by allowing the UE to mitigate the impact of CLI, particularly when SBFD is involved where simultaneous transmission and reception can cause interference.

Additionally, by enabling the UE to select antennas based on power consumption considerations, the described techniques can help reduce the overall power consumption and thermal overhead, making the system more efficient and suitable for cost-sensitive or power-constrained environments. In this way, the UE may conserve power resources and reduce thermal load. Furthermore, the ability to dynamically adjust antenna selection based on real-time CLI measurements ensures that the system can adapt to changing channel conditions, maintaining optimal performance. This dynamic adjustment may also help in conserving processing resources by mitigating or avoiding CLI issues.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

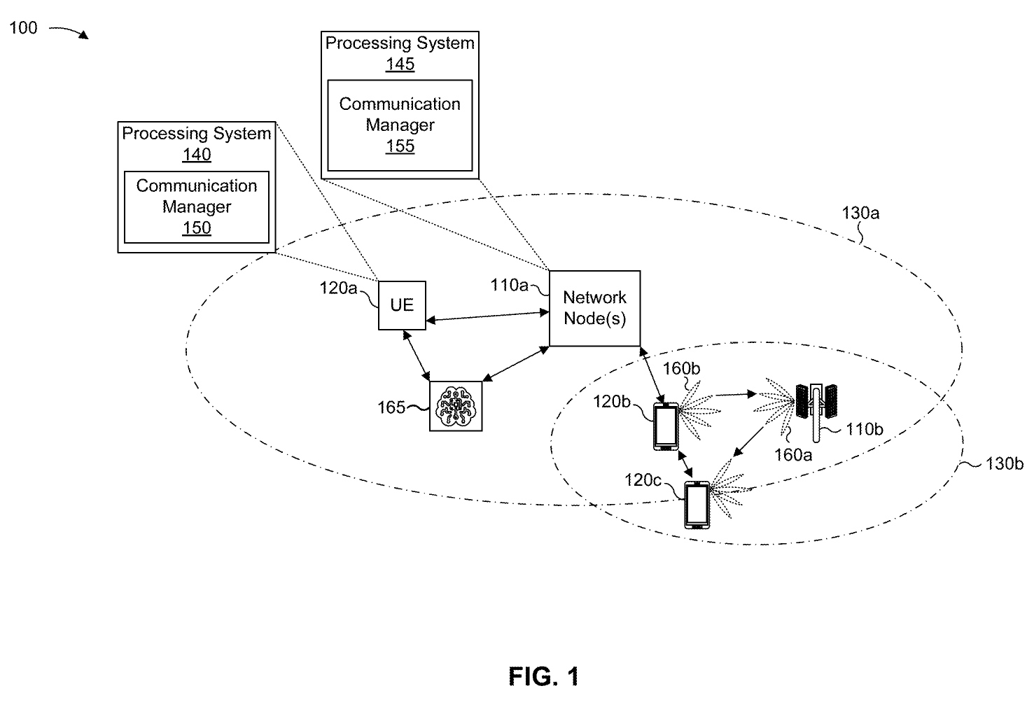

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by implementing a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., a UE 120) may include a communication manager 150. As described in more detail elsewhere herein, the communication manager 150 may receive multiple CSI metrics that are based at least in part on one or more CLI measurements; select a set of antennas for communication based at least in part on the multiple CSI metrics; and communicate a message using the selected set of antennas. Additionally, or alternatively, the communication manager 150 may perform one or more other operations described herein.

In some aspects, a network entity (e.g., a network node 110) may include a communication manager 155. As described in more detail elsewhere herein, the communication manager 155 may measure CLI based at least in part on reception of a reference signal on a first sub-band, during transmission of a message on a second sub-band as part of SBFD operation; and transmit multiple CSI metrics that are based at least in part on measured CLI. Additionally, or alternatively, the communication manager 155 may perform one or more other operations described herein.

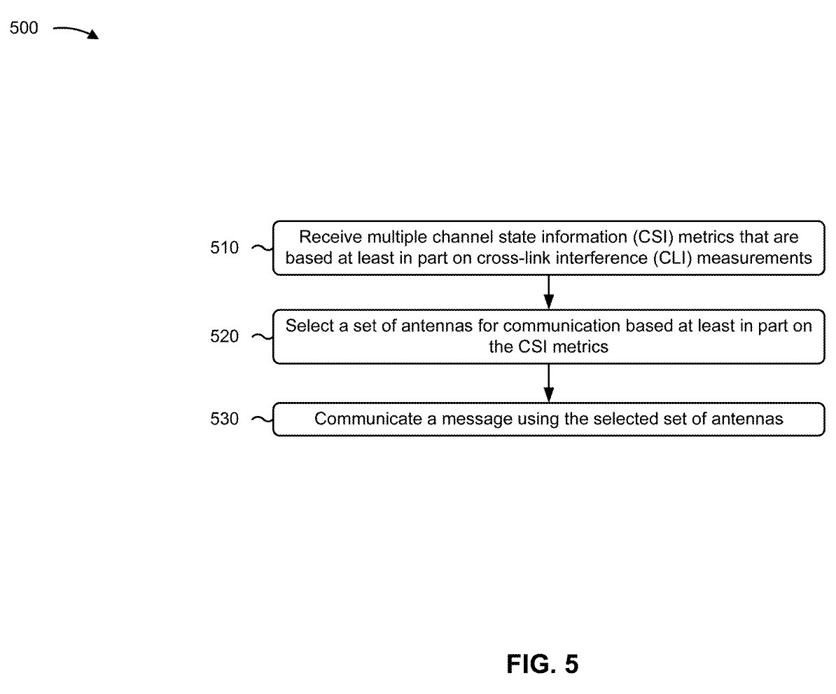

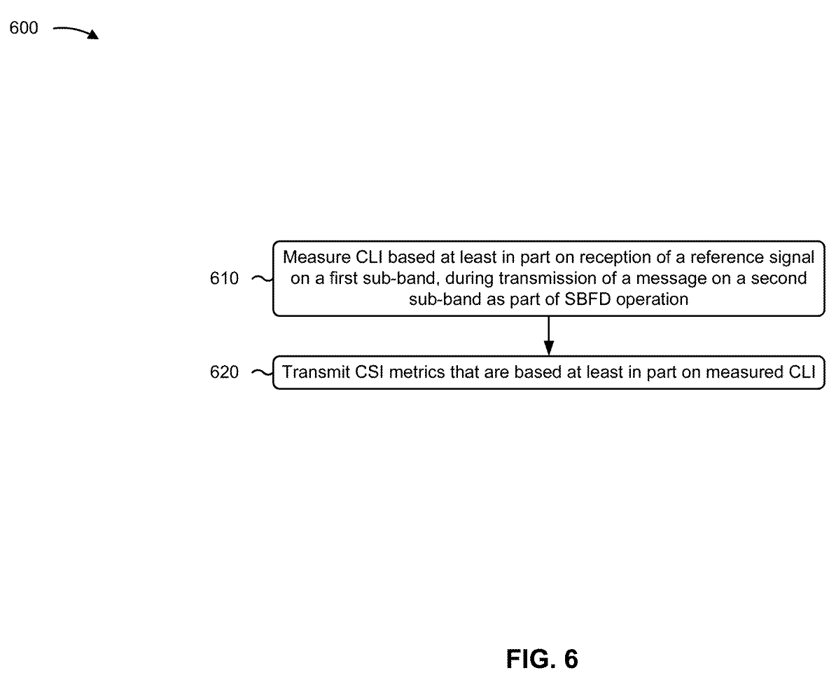

The network node 110, the processing system 145 of the network node 110, the UE 120, the processing system 140 of the UE 120, or any other component(s) of FIG. 1 may implement one or more techniques or perform one or more operations associated with antenna selection for SBFD, as described in more detail elsewhere herein. For example, the processing system 145 of the network node 110, or the processing system 140 of the UE 120 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

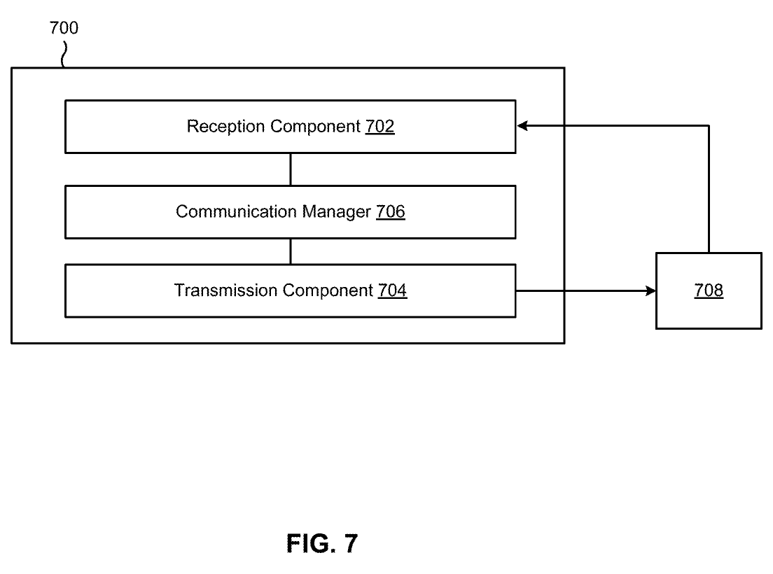

In some aspects, a UE (e.g., a UE 120) includes means for receiving multiple CSI metrics that are based at least in part on multiple CLI measurements; means for selecting a set of antennas for communication based at least in part on the multiple CSI metrics; or means for communicating a message using the selected set of antennas. In some aspects, the means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

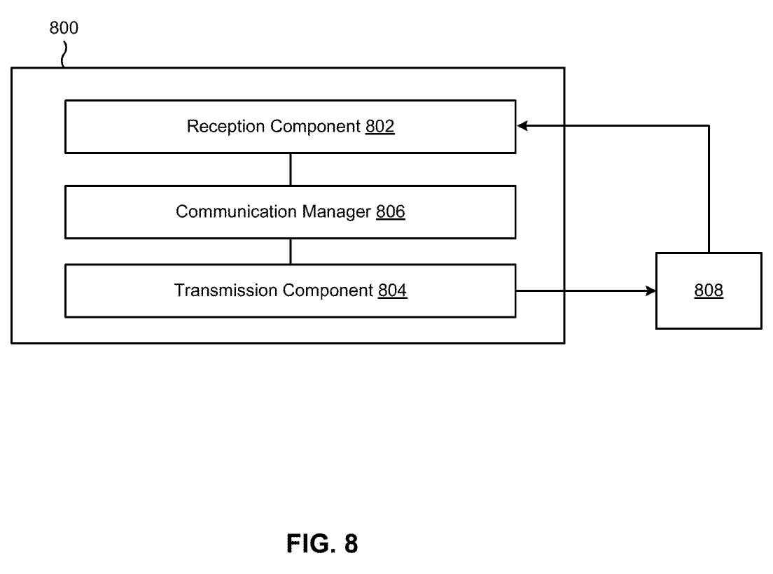

In some aspects, a network entity (e.g., a network node 110) includes means for measuring CLI based at least in part on reception of a reference signal on a first sub-band, during transmission of a message on a second sub-band as part of SBFD operation; or means for transmitting multiple CSI metrics that are based at least in part on the measured CLI. In some aspects, the means for the UE to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

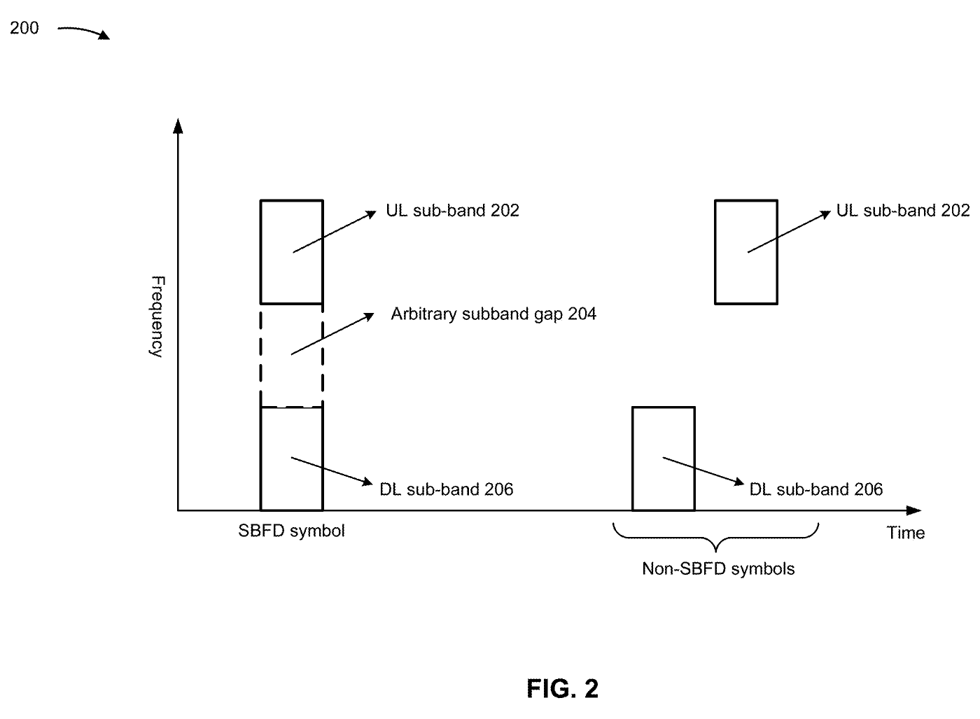

FIG. 2 is a diagram illustrating an example 200 of SBFD and non-SBFD symbols. Example 200 shows an example implementation of SBFD communication that includes multiple sub-bands and a gap. An UL sub-band 202 is used for transmitting SRS from a UE to a network entity, while a DL sub-band 206 is used for downlink transmissions (e.g., user data) from the network entity to the UE. The UL sub-band 202 may also be used for control signals, such as scheduling requests. For an SBFD symbol, the UL sub-band 202 and the DL sub-band 206 may be separated by an arbitrary sub-band gap 204. As a result of the arbitrary sub-band gap 204, the frequency domain characteristics of the UL and DL sub-bands can be quite different.

In some aspects, the UE may transmit SRSs in SRS opportunities while the network entity receives the SRSs on the UL sub-band. This configuration allows the network entity to estimate UL CQI and the corresponding MCS for the UL sub-band based on the SRSs. The CQI estimates for the UL sub-band are influenced by the properties of the UL sub-band as well as by CLI from the network entity transmissions. This includes interference from the network entity itself and from other network entities’ DL transmissions leaking into the UL sub-band.

Additionally, example 200 shows non-SBFD symbols where the uplink sub-band 202 and the downlink sub-band 206 are used at different times, avoiding simultaneous transmission and reception over different sub-bands. This separation in time rather than frequency helps to further reduce CLI.

In the case of non-SBFD UL symbols, the network entity may estimate CQI without the impact of CLI. This results in more accurate CQI estimates for non-SBFD symbols compared to SBFD symbols, which are affected by CLI. The absence of CLI in non-SBFD symbols leads to better CQI estimates, providing a clearer picture of the channel conditions.

From these estimates, the network entity may also derive CQI for the DL sub-band. Both the CQI estimates for the UL and DL sub-bands are valuable for the UE, as they provide comprehensive information about the UL and DL channel conditions. This information enables the UE to make informed decisions about antenna selection and transmission parameters, optimizing communication performance and efficiency.

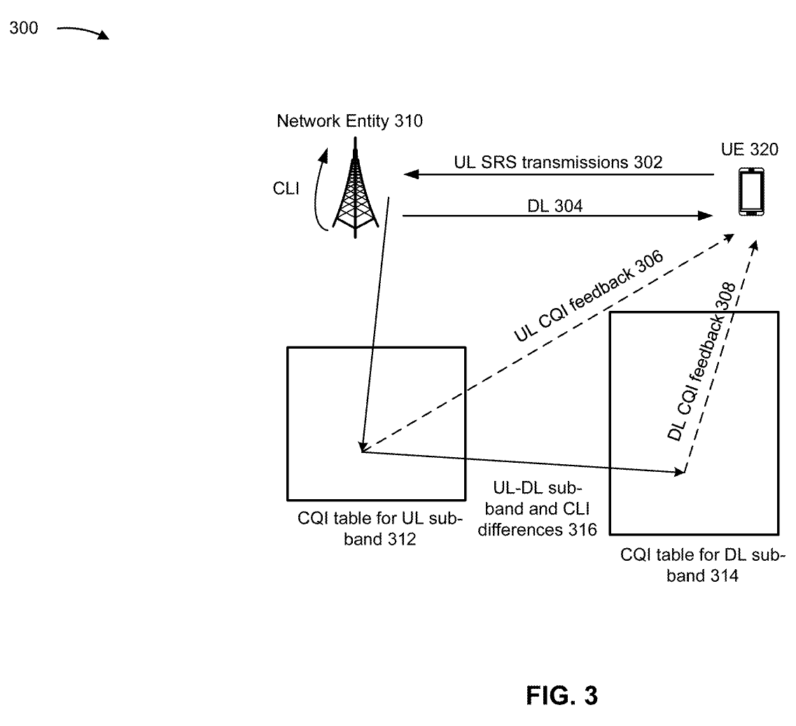

FIG. 3 is a diagram illustrating an example 300 of CQI feedback. For the SBFD symbols, a network entity estimates the CQI for the DL sub-band by considering the frequency domain differences between the UL and DL sub-bands. In some aspects, the network entity may account for CLI that may affect the UL reception. This CLI can originate from its own transmitter or from other network entities. By removing or mitigating this CLI, the network entity can provide more accurate CQI estimates for the DL sub-band.

The network entity may then provide CSI feedback, including CQI for both the UL and DL sub-bands. This feedback includes an indication of whether it is based on potential CLI removal in SBFD symbols or the absence of CLI from its own transmitter, particularly if there is no downlink transmission from the network entity at the time of measurement. The extent of CLI removal can vary depending on the complexity of the network entity. The network entity may quantify and indicate the level of CLI suppression to the UE, allowing the UE to assess the usefulness of the feedback. Additionally, CLI removal may be influenced by the network entity scheduling on the downlink.

For non-SBFD symbols, there is no impact of CLI, and the network entity provides CSI feedback for the UL and DL sub-bands separately. This separation ensures that the feedback for non-SBFD symbols is not affected by interference, leading to more reliable and accurate CQI estimates. The UE can use this feedback to optimize its communication parameters and enhance overall performance.

Example 300 shows a network entity 310 (e.g., network node 110) and a UE 320 (e.g., UE 120) participating in an SBFD communication process involving UL SRS transmissions 302 and DL transmissions 304. The network entity 310 measures CLI based on the reception of the UL SRS transmissions 302 while concurrently transmitting on the DL sub-band.

The network entity 310 then transmits UL CQI feedback 306 and DL CQI feedback 308 to the UE 320 that is based on the measured CLI. For example, the CQI feedback may include quality metrics that help the UE to optimize its transmission parameters and to select a set of antennas for communication with the network entity 310. The UL CQI feedback 306 may include multiple CSI metrics, such as SNR and MCS, while the DL CQI feedback 308 may include metrics for estimating downlink channel conditions. These CSI metrics provide detailed information about the channel state, aiding in better resource allocation and communication efficiency. Additionally, or alternatively, the network entity 310 may use advanced signal processing techniques to estimate CLI and provide refined CQI feedback to the UE 320. Such techniques improve the accuracy of CLI estimation, leading to more reliable CQI feedback.

In some aspects, the UL CQI feedback 306 is based on measurements from a CQI table for the UL sub-band 312, while the DL CQI feedback 308 is derived from a CQI table for the DL sub-band 314. These CSI metrics are influenced by UL-DL sub-band and CLI differences 316, which account for the varying frequency characteristics and interference levels between the sub-bands. The CSI metrics may include difference-in-sub-band-characteristic information.

In some aspects, the UE 320 may use the UL and DL CQI feedback (306 and 308) to dynamically adjust transmission parameters to optimize communication quality. For example, the UE 320 may modify its transmission power or modulation scheme based on the received CQI feedback. Additionally, or alternatively, the CLI measurements can be used to create a detailed interference profile, which helps in selecting the optimal set of antennas for communication. This profile provides insights into the interference landscape, assisting in making informed antenna selection decisions.

Alternatively, the network entity 310 may convey multiple UL CSI metrics to the UE, with each set of CSI metric configured for different sub-bands or even the same sub-band. This approach allows for a more detailed and nuanced understanding of the channel conditions across various frequency ranges. By providing multiple sets of CSI metrics, the network entity can offer a comprehensive view of the uplink channel quality, enabling the UE to make more informed decisions regarding antenna selection and transmission parameters.

The CSI metrics can utilize the existing CQI/MCS tables defined in the current 5G/6G specifications for uplink communications. Alternatively, a newly defined table specific to 6G can be used to accommodate the advanced requirements and capabilities of next-generation networks. These tables can be based on data derived from reference signals, control channels, or a combination of both, as transmitted by the UE. This flexibility ensures that the CSI metrics are tailored to the specific needs and conditions of the network, providing the most relevant and accurate information to the UE.

In addition to the standard CQI metrics, the network entity may also feedback alternative CSI metrics. These CSI metrics can include uplink (and estimated downlink) SNR values, which provide a measure of the signal quality relative to the background noise. Additionally, the CSI metrics may include UL (and estimated DL) channel impulse response (CIR) vector estimates, offering a more detailed representation of the channel characteristics. These alternative CSI metrics enhance the UE’s ability to optimize its communication strategies, ensuring robust and efficient performance in various network conditions.

In some aspects, the network entity 310 may provide detailed information to the UE 320 about the differences between UL and DL sub-bands, as well as the differences in the CLI information. This additional data empowers the UE 320 with a deeper understanding of the channel conditions, enabling the UE 320 to make more accurate and informed decisions regarding its communication strategies.

By receiving the UL-DL sub-band difference information, the UE 320 gains insights into the frequency domain characteristics and variations between the UL and DL sub-bands. This knowledge helps with understanding how the channel conditions may differ for transmissions and receptions on different sub-bands. Additionally, the CLI information provided by the network entity 310 helps the UE 320 to account for interference that may impact the channel quality, whether it originates from the network entity’s own transmissions or from other network entities in the vicinity.

With this comprehensive information, the UE 320 may estimate the DL CQI more accurately. By leveraging the UL CQI, along with the sub-band difference and CLI information, the UE 320 can make precise adjustments to its transmission parameters. This approach ensures that the UE 320 can optimize its communication performance, even in the presence of varying interference levels and sub-band characteristics. The result is a more robust and efficient communication system, capable of adapting to dynamic network conditions and maintaining high-quality connections.

Based on the multiple CSI metrics received from the network entity 310, the UE 320 may determine which set of K₁ antennas to use for UL communications and which set of K₂ antennas to use for DL communications. This selection process optimizes the performance and efficiency of the communication system. The UE 320 analyzes the CSI metrics provided by the network entity 310, including factors such as an UL CQI and CLI information. By leveraging this detailed feedback, the UE 320 can make informed decisions about which antennas will provide the best performance for both UL and DL transmissions.

The sets of antennas selected for UL and DL communications can be different or the same, depending on the specific requirements and conditions of the network. In some scenarios, using different sets of antennas for UL and DL may be advantageous to mitigate interference and optimize signal quality. For example, the UE 320 may select a set of antennas that are less affected by interference for UL transmissions, while selecting another set of antennas that offers better reception for DL communications. Alternatively, in cases where the channel conditions are relatively stable and interference is minimal, the same set of antennas may be used for both UL and DL, simplifying the configuration and reducing complexity.

Once the UE 320 has determined the optimal set of antennas, these selected antennas are used for subsequent communications (transmissions and receptions). This dynamic selection process ensures that the UE 320 can adapt to changing network conditions and maintain high-quality connections. By continuously evaluating the feedback from the network entity 310 and adjusting the antenna selection accordingly, the UE 320 can achieve efficient and reliable communication, enhancing overall network performance and user experience.

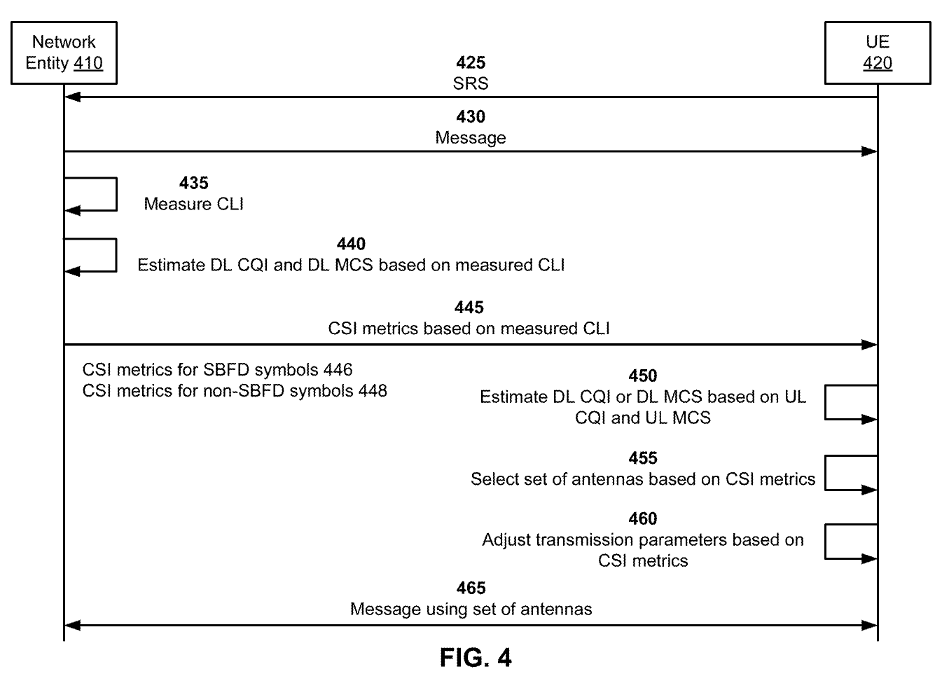

FIG. 4 is a diagram illustrating an example 400 of providing CSI metrics based on CLI measurements. Example 400 shows a network entity 410 (e.g., network node 110, network entity 310) and a UE 420 (e.g., UE 120, UE 320) perform a series of operations for antenna selection in an SBFD system. The process begins with the UE 420 transmitting an SRS to the network entity 410 in an UL sub-band (block 425) and the network entity 410 transmitting a message to the UE 420 in a DL sub-band (block 430). In response, the network entity 410 measures CLI (block 435) and estimates DL CQI based on the measured CLI (block 440).

In some aspects, the network entity 410 may also determine additional metrics such as SNR and CIR vector estimates to improve the accuracy of the DL CQI estimates. These additional metrics provide a more comprehensive view of the channel conditions, leading to better estimates. Additionally, or alternatively, the CSI metrics transmitted by the network entity 410 (block 445) can include both real-time and historical data to provide a comprehensive view of channel conditions. This combination of data types ensures that the UE has access to a wide range of information for making informed decisions. The CSI metrics may include UL CQIs and DL CQIs among other metrics.

The network entity 410 may then transmit CSI metrics that are based on the measured CLI (block 445), which may include CSI metrics for SBFD symbols 446 and CSI metrics for non-SBFD symbols 448. The UE 420 may utilize these CSI metrics to estimate a DL CQI based at least in part on an UL CQI (block 450).

The UE 420 may select a set of antennas based at least in part on the CSI metrics (block 455). Additionally, or alternatively, the UE 420 may use machine learning algorithms to analyze the CSI metrics and optimize antenna selection. These algorithms can identify patterns in the CSI metrics, helping the UE to select the best antennas for communication.

In some aspects, the UE 420 may adjust transmission parameters (block 460) based at least in part on a combination of CSI metrics and environmental factors such as mobility and interference levels. This approach ensures that the transmission parameters are optimized for the current communication environment.

The UE 420 may communicate a message (e.g., PUSCH, PUCCH, PDSCH, PDCCH) using the selected set of antennas (block 465). The message may include data, control information, or both to ensure robust communication. This flexibility allows the UE 420 to adapt to different communication needs and scenarios.

FIG. 5 is a diagram illustrating an example process 500 performed, for example, at a UE or an apparatus of a UE. Example process 500 is an example where the apparatus or the UE (e.g., UE 320, UE 420) performs operations associated with antenna selection for SBFD.

As shown in FIG. 5, in some aspects, process 500 may include receiving multiple CSI metrics that are based at least in part on multiple CLI measurements (block 510). For example, the UE (e.g., using reception component 702 or communication manager 706, depicted in FIG. 7) may receive multiple CSI metrics that are based at least in part on multiple CLI measurements, as described above in connection with FIGS. 3 and 4.

As further shown in FIG. 5, in some aspects, process 500 may include selecting a set of antennas for communication based at least in part on the multiple CSI metrics (block 520). For example, the UE (e.g., using communication manager 706, depicted in FIG. 7) may select a set of antennas for communication based at least in part on the multiple CSI metrics, as described above in connection with FIGS. 3 and 4.

As further shown in FIG. 5, in some aspects, process 500 may include communicating a message using the selected set of antennas (block 530). For example, the UE (e.g., using reception component 702, transmission component 704, or communication manager 706, depicted in FIG. 7) may communicate a message using the selected set of antennas, as described above in connection with FIGS. 3 and 4.

Process 500 may include additional aspects, such as any single aspect or any combination of aspects described below or in connection with one or more other processes described elsewhere herein.

In a first aspect, the multiple CSI metrics include a DL CQI or an UL CQI.

In a second aspect, alone or in combination with the first aspect, the multiple CSI metrics include multiple sets of CSI metrics, where different sets of CSI metrics corresponding to different operating sub-bands.

In a third aspect, alone or in combination with one or more of the first and second aspects, the multiple CSI metrics are differentiated based at least in part on whether the multiple CSI metrics are associated with SBFD symbols or associated with non-SBFD symbols.

In a fourth aspect, alone or in combination with one or more of the first through third aspects, the multiple CSI metrics include SNR values or signal strength values for uplink and downlink sub-bands.

In a fifth aspect, alone or in combination with one or more of the first through fourth aspects, selecting the set of antennas includes selecting the set of antennas from a total number of available antennas, and the total number of available antennas is based at least in part on power consumption metrics at the UE.

In a sixth aspect, alone or in combination with one or more of the first through fifth aspects, selecting the set of antennas includes selecting a first set of antennas for uplink and a second set of antennas for downlink.

In a seventh aspect, alone or in combination with one or more of the first through sixth aspects, the multiple CSI metrics include MCS estimates for uplink sub-bands.

In an eighth aspect, alone or in combination with one or more of the first through seventh aspects, process 500 includes adjusting transmission parameters based at least in part on the multiple CSI metrics.

In a ninth aspect, alone or in combination with one or more of the first through eighth aspects, the multiple CSI metrics include CIR vector estimates.

In a tenth aspect, alone or in combination with one or more of the first through ninth aspects, process 500 includes transmitting an SRS.

In an eleventh aspect, alone or in combination with one or more of the first through tenth aspects, the multiple CSI metrics include information about a difference between uplink sub-bands and downlink sub-bands and CLI information, and process 500 includes estimating a downlink CQI based at least in part on an uplink CQI, difference in sub-band characteristic information, and CLI information.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network entity or an apparatus of a network entity. Example process 600 is an example where the apparatus or the network entity (e.g., network entity 310, network entity 410) performs operations associated with providing CSI metrics based on CLI.

As shown in FIG. 6, in some aspects, process 600 may include measuring CLI based at least in part on reception of a reference signal on a first sub-band, during transmission of a message on a second sub-band as part of SBFD operation (block 610). For example, the network entity (e.g., using communication manager 806, depicted in FIG. 8) may measure CLI based at least in part on reception of a reference signal on a first sub-band, during transmission of a message on a second sub-band as part of SBFD operation, as described above in connection with FIGS. 3 and 4.

As further shown in FIG. 6, in some aspects, process 600 may include transmitting multiple CSI metrics that are based at least in part on measured CLI (block 620). For example, the network entity (e.g., using transmission component 804 or communication manager 806, depicted in FIG. 8) may transmit multiple CSI metrics that are based at least in part on measured CLI, as described above in connection with FIGS. 3 and 4.

Process 600 may include additional aspects, such as any single aspect or any combination of aspects described below or in connection with one or more other processes described elsewhere herein.

In a first aspect, process 600 includes estimating a downlink CQI based at least in part on the measured CLI, and the multiple CSI metrics include an indication of the downlink CQI or an uplink CQI.

In a second aspect, alone or in combination with the first aspect, process 600 includes estimating an MCS based at least in part on the measured CLI, and the multiple CSI metrics include an indication of the MCS.

In a third aspect, alone or in combination with one or more of the first and second aspects, the multiple CSI metrics include multiple sets of CSI metrics for uplink, each set of CSI metrics corresponding to a respective operating sub-band.

In a fourth aspect, alone or in combination with one or more of the first through third aspects, the multiple CSI metrics include SNR values or signal strength values for uplink and downlink sub-bands.

In a fifth aspect, alone or in combination with one or more of the first through fourth aspects, transmitting the multiple CSI metrics includes transmitting the multiple CSI metrics based at least in part on whether the multiple CSI metrics are associated with SBFD symbols or non-SBFD symbols.

In a sixth aspect, alone or in combination with one or more of the first through fifth aspects, process 600 includes transmitting feedback indicating a suppression level of the CLI, and the suppression level of the CLI is based at least in part on a complexity or downlink scheduling of the network entity.

In a seventh aspect, alone or in combination with one or more of the first through sixth aspects, the multiple CSI metrics include a CSI metric for the first sub-band and a CSI metric for the second sub-band.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 1-4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive multiple CSI metrics that are based at least in part on one or more CLI measurements. The communication manager 706 may select a set of antennas for communication based at least in part on the multiple CSI metrics. The reception component 702 and the transmission component 704 may communicate a message using the selected set of antennas.

The communication manager 706 may adjust transmission parameters based at least in part on the multiple CSI metrics.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network entity, or a network entity may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network entity.

In some aspects, the apparatus 800 may be configured to perform one or more operations described herein in connection with FIGS. 1-4. Additionally, or alternatively, the apparatus 800 may be configured to perform one or more processes described herein, such as process 600 of FIG. 6. In some aspects, the apparatus 800 or one or more components shown in FIG. 8 may include one or more components of the network entity described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network entity described above in connection with FIG. 1, such as a radio, one or more RF chains, one or more transceivers, or one or more modems, each of which may in turn be coupled with one or more antennas of the network entity.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The communication manager 806 may measure CLI based at least in part on reception of a reference signal on a first sub-band, during transmission of a message on a second sub-band as part of SBFD operation. The transmission component 804 may transmit multiple CSI metrics that are based at least in part on measured CLI.

The communication manager 806 may estimate a downlink CQI based at least in part on the measured CLI, and the multiple CSI metrics include an indication of the CQI. The communication manager 806 may estimate an MCS based at least in part on the measured CLI, and the multiple CSI metrics include an indication of the MCS.

The transmission component 804 may transmit feedback indicating a suppression level of the CLI, and the suppression level of the CLI is based at least in part on a complexity or downlink scheduling of the network entity.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by user equipment (UE), comprising: receiving multiple channel state information (CSI) metrics that are based at least in part on cross-link interference (CLI) measurements; selecting a set of antennas for communication based at least in part on the multiple CSI metrics; and communicating a message with the selected set of antennas.

Aspect 2: The method of Aspect 1, wherein the multiple CSI metrics include a downlink channel quality indicator (CQI) or an uplink CQI.

Aspect 3: The method of any of Aspects 1-2, wherein the multiple CSI metrics include multiple sets of CSI metrics, and wherein different sets of CSI metrics corresponding to different operating sub-bands.

Aspect 4: The method of any of Aspects 1-3, wherein the multiple CSI metrics are differentiated based at least in part on whether the multiple CSI metrics are associated with sub-band full duplex (SBFD) symbols or associated with non-SBFD symbols.

Aspect 5: The method of any of Aspects 1-4, wherein the multiple CSI metrics include signal-to-noise ratio (SNR) values or signal strength values for uplink and downlink sub-bands.

Aspect 6: The method of any of Aspects 1-5, wherein selecting the set of antennas includes selecting the set of antennas from a total number of available antennas, and wherein the total number of available antennas is based at least in part on power consumption metrics at the UE.

Aspect 7: The method of any of Aspects 1-6, wherein selecting the set of antennas includes selecting a first set of antennas for uplink and a second set of antennas for downlink.

Aspect 8: The method of any of Aspects 1-7, wherein the multiple CSI metrics include a modulation and coding scheme estimate or a channel quality indicator estimate for uplink sub-bands.

Aspect 9: The method of any of Aspects 1-8, further comprising adjusting transmission parameters based at least in part on the multiple CSI metrics.

Aspect 10: The method of any of Aspects 1-9, wherein the multiple CSI metrics include channel impulse response vector estimates.

Aspect 11: The method of any of Aspects 1-10, further comprising transmitting a sounding reference signal.

Aspect 12: The method of any of Aspects 1-11, wherein the multiple CSI metrics include information about a difference between uplink sub-bands and downlink sub-bands and CLI information, and wherein the method includes estimating a downlink channel quality indicator (CQI) or a downlink modulation and coding scheme (MCS) based at least in part on an uplink CQI or an uplink MCS, difference in sub-band characteristic information, and CLI information.

Aspect 13: A method of wireless communication performed by a network entity, comprising: measuring cross-link interference (CLI) based at least in part on reception of a reference signal on a first sub-band, during transmission of a message on a second sub-band as part of sub-band full-duplex (SBFD) operation; and transmitting multiple channel state information (CSI) metrics that are based at least in part on measured CLI.

Aspect 14: The method of Aspect 13, further comprising estimating a downlink channel quality indicator (CQI) based at least in part on the measured CLI, and wherein the multiple CSI metrics include an indication of the downlink CQI or an uplink CQI.

Aspect 15: The method of any of Aspects 13-14, further comprising estimating a modulation and coding scheme (MCS) based at least in part on the measured CLI, and wherein the multiple CSI metrics include an indication of the MCS.

Aspect 16: The method of any of Aspects 13-15, wherein the multiple CSI metrics include multiple sets of CSI metrics for uplink, each set of CSI metrics corresponding to a respective operating sub-band.

Aspect 17: The method of any of Aspects 13-16, wherein the multiple CSI metrics include signal-to-noise ratio (SNR) values or signal strength values for uplink and downlink sub-bands.

Aspect 18: The method of any of Aspects 13-17, wherein transmitting the multiple CSI metrics includes transmitting the multiple CSI metrics based at least in part on whether the multiple CSI metrics are associated with SBFD symbols or non-SBFD symbols.

Aspect 19: The method of any of Aspects 13-18, further comprising transmitting feedback indicating a suppression level of the CLI, and wherein the suppression level of the CLI is based at least in part on a complexity or downlink scheduling of the network entity.

Aspect 20: The method of any of Aspects 13-19, wherein the multiple CSI metrics include a CSI metric for the first sub-band and a CSI metric for the second sub-band.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 28: A device comprising a processing system that includes one or more processors and one or more code-storing memories coupled with the one or more processors, the processing system configured to cause the device to perform the method of one or more of Aspects 1-20.

Aspect 29: A device comprising a processing system that includes processor circuitry and code-storing memory circuitry, the processing system configured to cause the device to perform the method of one or more of Aspects 1-20.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive multiple channel state information (CSI) metrics that are based at least in part on multiple cross-link interference (CLI) measurements;
select a set of antennas for communication based at least in part on the multiple CSI metrics; and
communicate a message using the selected set of antennas.

2. The UE of claim 1, wherein the multiple CSI metrics include a downlink channel quality indicator (CQI) or an uplink CQI.

3. The UE of claim 1, wherein the multiple CSI metrics include multiple sets of CSI metrics, and wherein different sets of CSI metrics corresponding to different operating sub-bands.

4. The UE of claim 1, wherein the multiple CSI metrics are differentiated based at least in part on whether the multiple CSI metrics are associated with sub-band full duplex (SBFD) symbols or associated with non-SBFD symbols.

5. The UE of claim 1, wherein the multiple CSI metrics include signal-to-noise ratio (SNR) values or signal strength values for uplink and downlink sub-bands.

6. The UE of claim 1, wherein the processing system, to cause the UE to select the set of antennas, is configured to cause the UE to select the set of antennas from a total number of available antennas, and wherein the total number of available antennas is based at least in part on power consumption metrics at the UE.

7. The UE of claim 1, wherein the processing system, to cause the UE to select the set of antennas, is configured to cause the UE to select a first set of antennas for uplink and a second set of antennas for downlink.

8. The UE of claim 1, wherein the multiple CSI metrics include a modulation and coding scheme estimate or a channel quality indicator estimate for uplink sub-bands.

9. The UE of claim 1, wherein the processing system is configured to cause the UE to adjust transmission parameters based at least in part on the multiple CSI metrics.

10. The UE of claim 1, wherein the multiple CSI metrics include channel impulse response vector estimates.

11. The UE of claim 1, wherein the processing system is configured to cause the UE to transmit a sounding reference signal.

12. The UE of claim 1, wherein the multiple CSI metrics include information about a difference between uplink sub-bands and downlink sub-bands and CLI information, and wherein the processing system is configured to estimate a downlink channel quality indicator (CQI) or a downlink modulation and coding scheme (MCS) based at least in part on an uplink CQI, an uplink MCS, a difference in sub-band characteristic information, and CLI information.

13. A network entity, comprising:
a processing system that includes one or more processors and one or more code-storing memories coupled with the one or more processors, the processing system configured to cause the network entity to:
measure cross-link interference (CLI) based at least in part on reception of a reference signal on a first sub-band, during transmission of a message on a second sub-band as part of sub-band full-duplex (SBFD) operation; and
transmit multiple channel state information (CSI) metrics that are based at least in part on measured CLI.

14. The network entity of claim 13, wherein the processing system is configured to cause the network entity to estimate a downlink channel quality indicator (CQI) based at least in part on the measured CLI, and wherein the multiple CSI metrics include an indication of the downlink CQI or an uplink CQI.

15. The network entity of claim 13, wherein the processing system is configured to cause the network entity to estimate a modulation and coding scheme (MCS) based at least in part on the measured CLI, and wherein the multiple CSI metrics include an indication of the MCS.

16. The network entity of claim 13, wherein the multiple CSI metrics include multiple sets of CSI metrics for uplink, each set of CSI metrics corresponding to a respective operating sub-band.

17. The network entity of claim 13, wherein the multiple CSI metrics include signal-to-noise ratio (SNR) values or signal strength values for uplink and downlink sub-bands.

18. The network entity of claim 13, wherein the processing system, to cause the network entity to transmit the multiple CSI metrics, is configured to cause the network entity to transmit the multiple CSI metrics based at least in part on whether the multiple CSI metrics are associated with SBFD symbols or non-SBFD symbols.

19. The network entity of claim 13, wherein the processing system is configured to cause the network entity to transmit feedback indicating a suppression level of the CLI, and wherein the suppression level of the CLI is based at least in part on a complexity or downlink scheduling of the network entity.

20. The network entity of claim 13, wherein the multiple CSI metrics include a CSI metric for the first sub-band and a CSI metric for the second sub-band.
